(19) United States
(12) Patent Application Publication
(10) Pub. No.: US 2024/0246430 A1
(43) Pub. Date: Jul. 25, 2024

(54) CHARGE PORT PILOT COMMUNICATION LINES WITH SWITCHES AND CONTROL OF SAME

(71) Applicant: FORD GLOBAL TECHNOLOGIES, LLC, Dearborn, MI (US)

(72) Inventor: Pedro Chavez, JR., Adrian, MI (US)

(21) Appl. No.: 18/156,713

(22) Filed: Jan. 19, 2023

(51) Int. Cl. B60L 53/16; B60L 50/60; B60L 53/60; H01M 10/46; H02J 7/00

(52) U.S. Cl. CPC B60L 53/16; B60L 50/60; B60L 53/60; H01M 10/46; H02J 7/0029; H02J 7/0047; H02J 7/0071; H01M 2220/20

(57) ABSTRACT

A controller of a charge system, in response to detecting occurrence of a predefined condition, commands switches of pilot and proximity communication lines to open. This severs a physical communication link between a charge port that is configured to receive a plug of electric vehicle supply equipment and the controller. The controller, after expiration of a predetermined period of time, may command the switches to close to reestablish the physical communication link.

### TECHNICAL FIELD

This disclosure relates to automotive power systems.

### BACKGROUND

An electrified vehicle may include a traction battery and an electric machine. Electric power from the traction battery may be supplied to the electric machine. The electric machine may convert the electric power to mechanical power to propel the vehicle.

The traction battery may be charged with electric power from a charge station. A cord set is sometimes used to connect the charge station and vehicle via a plug. This plug is often manually installed by a user.

Electric vehicle supply equipment (EVSE) can include electrical conductors, related equipment, software, and communication protocols that deliver energy to vehicles. EVSE can be classified as Level 1 (120 volts AC), Level 2 (240 volts, AC), and DC Fast Charger (480 volts DC and higher).

### SUMMARY

A vehicle includes a charge port that can receive a plug of electric vehicle supply equipment, a controller, and pilot and proximity communication lines including switches that establish a physical communication link between the charge port and controller when the switches are closed and sever the link when the switches are open.

The vehicle may further include a controller that, responsive to occurrence of a predefined condition, commands the switches to open for a predefined duration, and following expiration of the predefined duration, commands the switches to close. The controller may further, following a predetermined number of cycles in which, for each of the cycles, the switches are opened and closed, preclude the switches from being opened. The controller may further, following a predetermined number of cycles in which, for each of the cycles, the switches are opened and closed, preclude the switches from being closed. The controller may further generate an alert after the switches are closed. The switches may be relays. The vehicle may further include a traction battery that receives electric power via the charge port during a charge operation.

A charge system of a vehicle includes a controller that, responsive to detecting occurrence of a predefined condition, commands switches of pilot and proximity communication lines to open to sever a physical communication link between a charge port configured to receive a plug of electric vehicle supply equipment and the controller.

The predefined condition may be a timeout or fault. The controller may further, following a predetermined period of time beginning with opening of the switches, command the switches to close. The controller may further, following a predetermined number of cycles in which, for each of the cycles, the switches are opened and closed, preclude the switches from being opened. The controller may further, following a predetermined number of cycles in which, for each of the cycles, the switches are opened and closed, preclude the switches from being closed. The controller may generate an alert after the switches are opened. The switches may be relays.

A method includes, responsive to expiration of a predetermined period of time, closing a switch of a pilot communication line to reestablish a physical communication link between a charge port of a vehicle configured to receive a plug of electric vehicle supply equipment and a controller.

The method may further include, responsive to detecting occurrence of a predefined condition, opening the switches. The predefined condition may be a timeout or fault. The method may further include generating an alert after the opening.

### BRIEF DESCRIPTION OF THE DRAWINGS

FIG. 1 is a block diagram of example electric vehicle supply equipment and an example vehicle.

FIG. 2 is a flow chart of an algorithm for controlling the relays of FIG. 1.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Current standards require disconnecting a charge cable and reconnecting it following an unsuccessful charge attempt. Several software functions are present to permit retry of the unsuccessful charge attempt but are restricted by electric vehicle supply equipment (EVSE) standards. Customers, for example, must monitor the EVSE and vehicle to ensure a charge cycle starts.

Here additional switches (e.g., relays, etc.) are proposed that will allow customers to plug in their vehicle and not concern themselves with whether the charge cycle is successful. Such relays could be controlled by a battery control module or other controller(s) and would simulate a disconnect and reconnect of the charge plug.

Under normal circumstances, when a fault or timeout occurs, the user would be required to unplug and reconnect the charge cable. The proposed relays would allow the vehicle to mimic an unplug and reconnect of the charge cable without the user physically unplugging the cable. This will reset any on-board charger and battery control module to initiate a new charging session. If this issue occurs multiple times, the on-board charger and battery control module can be programmed to count the number of retries and stop the cycle to declare a true fault if some predetermined number (e.g., 3) of retries occurs.

When a timeout occurs during the cable check, pre-charge, communication, authorization, ready-to-charge, or on-going timer periods, the battery control module can open the relays for a predefined duration (e.g., 3 seconds, 5 seconds, etc.) and then close the relays. When a fault occurs that leads to a terminate communication condition, the battery control module can open the relays for the predefined duration and then close the relays. When the battery control module closes the relays after a fault that leads to the terminate communication condition, the battery control module can transmit an alert to a user and/or to the on-board charge controller (and any other modules that need it) that a retry has occurred for retry counter management.

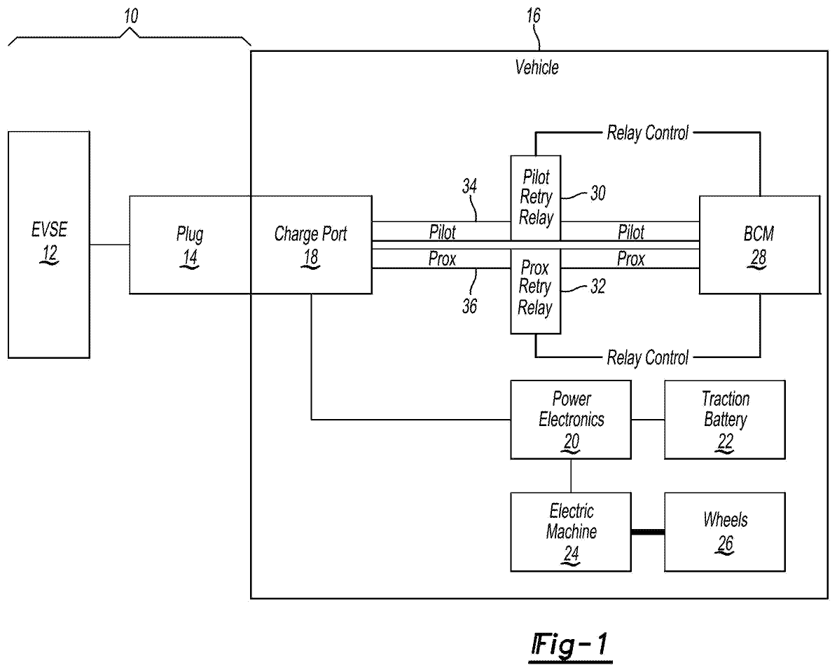

Referring to FIG. 1, electric vehicle supply equipment 10 includes a charging station 12 and a plug 14. A vehicle 16 includes, among other things, a charge port 18, power electronics 20, a traction battery 22, an electric machine 24, and wheels 26. The vehicle 16 also includes a battery control module 28, pilot and proximity relays 30, 32, and pilot and proximity lines 34, 36.

During charge, electric power from the charging station 12 received at the charge port 18 is conditioned by the power electronics 20 before being provided to the traction battery 22 for storage. During vehicle operation, electric power from the traction battery 12 is conditioned by the power electronics 20 before being provided to the electric machine 24. The electric machine 24 transforms this electric power to mechanical power to propel the wheels 26. The electric machine 24, during regenerative braking, captures mechanical power from the wheels 26 and transforms this mechanical power to electric power for storage in the traction battery 22.

The pilot and proximity lines 34, 36 provide a physical communication link between the charge port 18 and battery control module 28. The pilot and proximity relays 30, 32 are arranged on the pilot and proximity lines 34, 36 respectively such that when the pilot and proximity relays 30, 32 are open, the physical communication link between the charge port 18 and battery control module 28 is severed-thus preventing pilot communication with the plug 14 and EVSE 12. As mentioned above, this simulates conditions when the plug 14 is disconnected from the charge port 18. This pilot and proximity circuitry, in some architectures, includes a voltage divider. As such, it can be sensitive to changes in resistance and voltage. The pilot and proximity relays 30, 32 should therefore be positioned before the voltage divider in order to operate as intended and deliver the proper signal to the EVSE 12.

The battery control module 28 is in communication with and controls the pilot and proximity relays 30, 32 as described below.

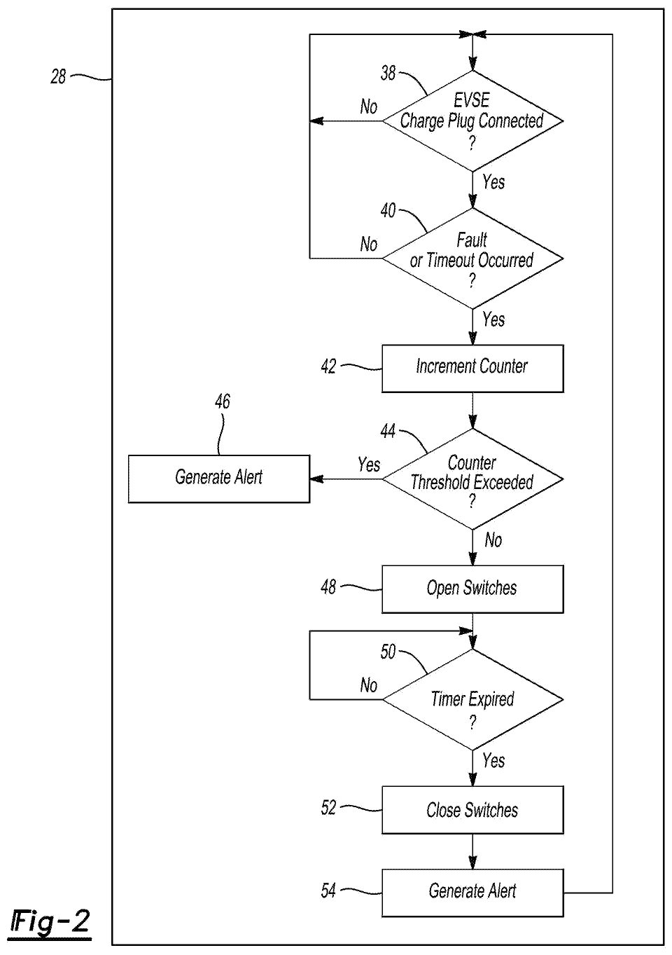

Referring to FIG. 2, it is determined whether an EVSE charge plug is connected with a charge port at operation 38. The battery control module 28 may detect standard signals from known proximity sensors to determine whether the plug 14 is connected with the charge port 18. If no, the algorithm returns to operation 38. If yes, it is determined whether a fault or timeout condition has occurred at operation 40. The battery control module 28 may detect standard signals indicating a fault or timeout has occurred during the cable check, pre-charge, communication, authorization, etc. time periods as suggested above. Signals containing certain information may be indicative of a fault as known in the art. Absence of expected signals may be indicative of a timeout, again as known in the art. If no, the algorithm returns to operation 38. If yes, a counter is incremented at operation 42. At operation 44 it is determined whether a counter threshold is exceeded. The battery control module 28 may compare a current value of the counter with the counter threshold. If yes, an alert is generated at operation 46. If no, switches are opened at operation 48. The battery control module 28 may command the pilot and proximity relays 30, 32 to open to sever the physical communication link between the charge port 18 and battery control module 28. At operation 50, it is determined whether a timer has expired. The battery control module 28 may initiate a timer upon the pilot and proximity relays 30, 32 being opened. If no, the algorithm returns to operation 50. If yes, the switches are closed at operation 52. The battery control module 28 may command the pilot and proximity relays 30, 32 to close to reestablish the physical communication link between the charge port 18 and battery control module 28. At operation 54, an alert is generated. The algorithm then returns to operation 38.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials. The terms “controller” and “controllers,” for example, can be used interchangeably herein.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle including:
a charge port configured to receive a plug of electric vehicle supply equipment;
a controller; and
pilot and proximity communication lines including switches configured to establish a physical communication link between the charge port and controller when the switches are closed and to sever the link when the switches are open.

2. The vehicle of claim 1 further comprising a controller programmed to, responsive to occurrence of a predefined condition, command the switches to open for a predefined duration, and following expiration of the predefined duration, command the switches to close.

3. The vehicle of claim 2, wherein the controller is further programmed to, following a predetermined number of cycles in which, for each of the cycles, the switches are opened and closed, preclude the switches from being opened.

4. The vehicle of claim 2, wherein the controller is further programmed to, following a predetermined number of cycles in which, for each of the cycles, the switches are opened and closed, preclude the switches from being closed.

5. The vehicle of claim 1, wherein controller is further programmed to generate an alert after the switches are closed.

6. The vehicle of claim 1, wherein the switches are relays.

7. The vehicle of claim 1 further comprising a traction battery configured to receive electric power via the charge port during a charge operation.

8. A charge system of a vehicle comprising:
a controller programmed to, responsive to detecting occurrence of a predefined condition, command switches of pilot and proximity communication lines to open to sever a physical communication link between a charge port configured to receive a plug of electric vehicle supply equipment and the controller.

9. The charge system of claim 8, wherein the predefined condition is a timeout or fault.

10. The charge system of claim 8, wherein the controller is further programmed to, following a predetermined period of time beginning with opening of the switches, command the switches to close.

11. The charge system of claim 10, wherein the controller is further programmed to, following a predetermined number of cycles in which, for each of the cycles, the switches are opened and closed, preclude the switches from being opened.

12. The charge system of claim 10, wherein the controller is further programmed to, following a predetermined number of cycles in which, for each of the cycles, the switches are opened and closed, preclude the switches from being closed.

13. The charge system of claim 8, wherein the controller is further programmed to generate an alert after the switches are opened.

14. The charge system of claim 8, wherein the switches are relays.

15. A method comprising:
responsive to expiration of a predetermined period of time, closing a switch of a pilot communication line to reestablish a physical communication link between a charge port of a vehicle configured to receive a plug of electric vehicle supply equipment and a controller.

16. The method of claim 15 further comprising, responsive to detecting occurrence of a predefined condition, opening the switch.

17. The method of claim 16, wherein the predefined condition is a timeout or fault.

18. The method of claim 16 further comprising generating an alert after the opening.
